(19) United States
(12) Patent Application Publication
(10) Pub. No.: US 2016/0267473 A1
(43) Pub. Date: Sep. 15, 2016

(54) Method for ranking of currencies in a payment system with a multitude of issuers

(71) Applicant: Svetoslav Lazarov Gramenov, Varna (BG)

(72) Inventor: Svetoslav Lazarov Gramenov, Varna (BG)

(21) Appl. No.: 14/656,749

(22) Filed: Mar. 13, 2015

(51) Int. Cl. G06Q 20/38; G06F 17/30

(52) U.S. Cl. CPC G06Q 20/381; G06F 17/3053; G06F 17/30864

(57) ABSTRACT

The invention provides a method for application of statistical methods to rank various currencies in a payment system, wherein currencies are created in the same pattern but have different parameters and different user-acceptance rates, which together are used for the assignment of a rating to each currency and ranking of the currencies according to the ratings. Currency ratings are a function parameters, each parameter being the numerical value of a time series data set: amount of currency in circulation, the number of times a currency is used in transactions, number of different users accepting the currency, back-up level (redeemability) of currency and market value of the currency. These five main parameters can be combined so as to arrive at independent variables, each independent variable having a different weight in the determination of currency ratings; the weights (coefficients) themselves can be customized by the operator of the system.

### BACKGROUND

1. Field of Invention

The current disclosure relates generally to the operation of a payment system with multiple currencies and the ranking of the currencies according to their market value, redeemability and the consumer attitudes towards the currency.

2. Description of the Related Art

Ranking of money is a method applicable to payment systems where various media of exchange are used. When speaking of existing methods for money ranking we usually refer to the comparison of different types of the existing national currencies. All of these methods involve currencies which are issued by some sort of central national/supranational authority—like a national/supranational central bank (The Federal Reserve, the European Central Bank), or by a government. Thus, for example, the exchange rate between currencies can be interpreted as a method for ranking of currencies by comparing their relative values. The method, however, is not only just one-dimensional, but is also limited in its applicability to calculations for the value of money with legal tender status only.

Another type of money, however, does exist. This is money created by private entities or simply put private currencies. When created under the same pattern, these currencies can easily circulate in a common payment system. For example a prepaid access card issued by a certain merchant which is also accepted at par value or even at some other value by another merchant. When a group of merchants starts issuing such cards and agree to accept and redeem the cards issued by the members of the group, a payment system is created with a multitude of private currencies, created under the same pattern. When many members are included in this private payment system it will become obvious that a prepaid access card issued by one merchant shouldn't have the same value as a card issued by another merchant for various reasons like different values and qualities of goods and services, brand name, etc. So these prepaid access cards acting as private currencies will have different values compared to each other. Another parameter that can be used for rating such private currencies in a common payment system is the level of redeemability of the currency. While merchant A can only offer goods and services for 50 percent of the currency units, issued by him, merchant B can redeem 100 percent of his currency units. Thus currencies can also be ranked according to their redeemability level. Many parameters can be used for rating such currencies. However, currently no such methods exist in payment systems with privately-issued currencies.

Rating methods are almost entirely applied to national currencies. Most attempts for currency rating have been associated with comparing the value of one currency to the value of another one. For example 1 unit of gold may be considered 10 times more valuable than 1 unit of silver. And 1 unit of silver respectively may be considered 10 times more valuable than 1 unit of copper. These three basic types of metal currency (gold, silver and copper) can all circulate in the same payment system but have an assigned rating.

Another example of currency rating is the exchange rate determined by authorities or markets. Depending on the market value of currencies and various economic forecasts, national currencies are compared to each other in order to calculate an exchange rate which can be used to rank the currencies according to their value.

The methods which are currently used for currency ratings are mainly based on predictions for the state of the issuer, the amount of goods and services that can be bought with the respective currency and the market value of the currency on the forex market. These rating methods however serve specific purposes and are only good to be used by certain participants in the payment system like investors, forex traders/speculators and central banks. Different rating methods should also be applied to alternative payment systems where various currencies are used in order for all users of the system to benefit from them and choose what type of currency to use.

One of the parameters which rating agencies and other entities engaged in rating of currencies never use is the attitude of the participants in the payment system towards a specific type of money. This is mainly due to the fact that payment systems rarely offer a choice in currency and users of these systems cannot express their preference of one currency to another, except through interactions on the forex market for national legal tender notes.

As it is commonly quoted in marketing and in Internet developments, “millions can't be wrong” and “given enough eyeballs all bugs are shallow”. The collective experience and the preferences of users of a certain payment system may be the best way to rank different currencies in this system. A method that uses such data is certainly possible to implement in a network-based payment system where various currencies are used as mediums of exchange and users are entitled to choose whether to use one currency or another when transacting value.

### REFERENCE TO SPECIFIC DOCUMENTS RELATED TO THE INVENTION

### US Patent Documents

Application Ser. No. 12/078395, Mar. 31, 2008;

Application Ser. No. 09/639533, Aug. 16, 2000;

Application Ser. No. 13/824324, Mar. 5, 2014

### SUMMARY

This section explains how the invention overcomes the problems pointed out in the background. A method for currency rating is provided that uses market value of the currency, its redeemability, as well as the collective user attitudes towards the currency.

The method uses statistical tools to measure changes in the rating parameters of the currencies over a certain preset past period of time. The rating is always measured in real time, but data from a certain past period of time to the point of measurement is used in the calculation.

The method can be implemented in a payment system with various types of private currencies. The currencies are created on the initiative of the users of the payment system. The currency issued by a certain user represents his obligation to redeem the currency for the respective amount of goods and services. The currencies are created in the same pattern and have at least the following parameters: market value representing the exchange rate for a public currency in the system, and back-up level associated with the amount of goods and services for which the currency can be redeemed over a certain period of time. The system must also be capable of keeping record of all units of a certain currency in circulation and the number of transactions executed with a certain currency by the users.

Different currencies in the system are assigned a rating as a function of three independent variables—velocity of the currency, market value and back-up level. The velocity of the currency depends on three additional parameters—the total amount of the currency in circulation, how much of the currency has been involved in transactions over a certain period of time and how many of the users of the system have participated in these transactions. The parameters have fluctuating weight in determining the currency rating thus the method can be customized by the operator of the payment system to serve its needs as efficiently as possible.

The market value of the currency represents the exchange rate of the currency for a specific currency in the system, preferably a currency issued by the operator of the system—a public currency. The market value is determined through a common price discovery process in a money market implemented in the system where users can post bids and offers for currencies.

The back-up level of a currency represents its redeemability for goods and services, offered by the issuer of the currency over a certain period of time. Presumably the issuer operates a business and is willing to accept the currency, issued by him for his goods or services. The back-up level of the currency indicates how much of the currency in circulation can be spent for these goods and services and this coefficient depends on data, presented by the issuer.

The method can be implemented in a system based on a network which connects data processing devices of users with a server and a database. The server executes transactions between the users, receives and extracts data and records in the database. The server also calculates the rating of all currencies and ranks them.

### BRIEF DESCRIPTION OF DRAWINGS

FIG. 1 illustrates the application of the method and the interactions between the participants in the payments system from which data is extracted or provided to be used for the currency rating calculation.

FIG. 2 presents the method as a flow chart and shows the basic step in the process of rating establishment.

FIG. 3 illustrates the process of private money issuance and redemption.

FIG. 4 depicts the process or retrieving the rating parameters.

FIG. 5 shows the process of retrieving the currency velocity rating parameter

FIG. 6 presents a simple example of a currency discovery process for establishment of market value of the currency.

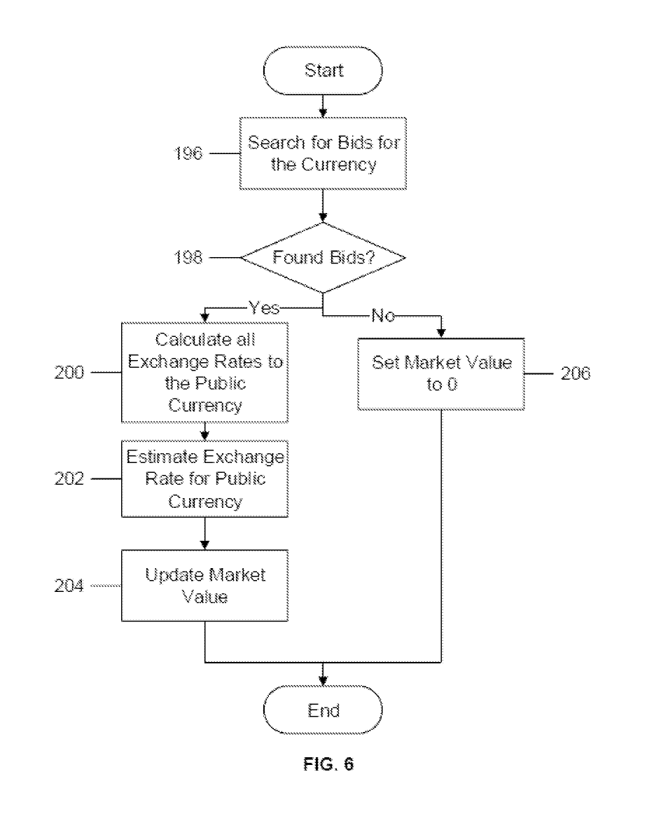

FIG. 7 shows the Back-up level establishment and alteration over a given period of time.

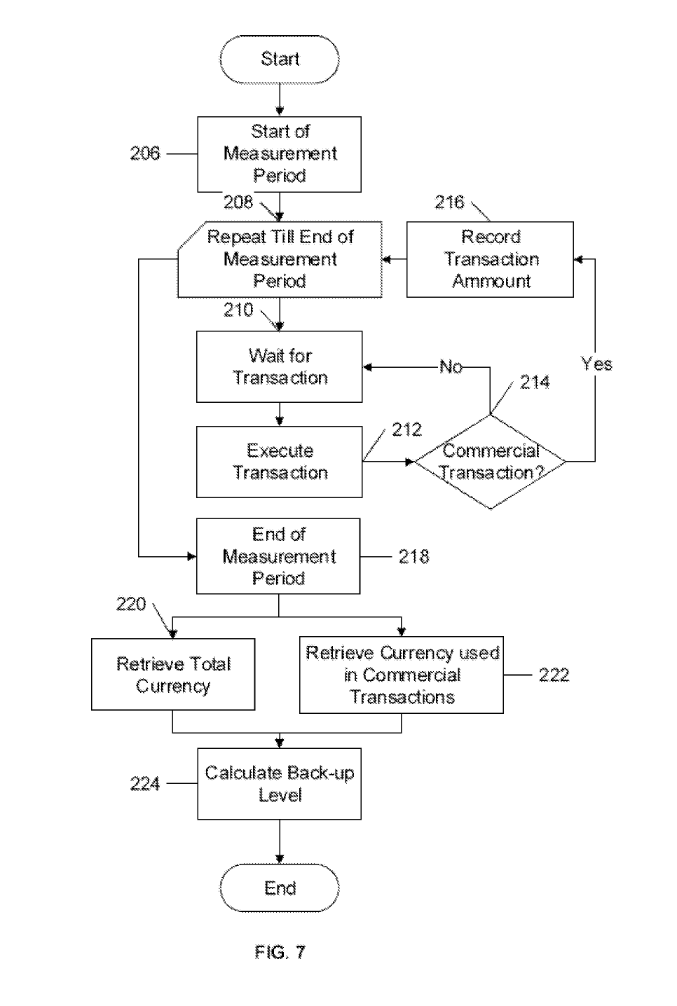

### DETAILED DESCRIPTION

An exemplary embodiment, as described below, may be used to provide a method for rating and ranking currencies in a payment system with a multitude of mediums of exchange, created in the same pattern

### Currency Pattern

The method should be implemented within a digital payment system with multitude of currencies all having the same basic structure and parameters which are used for establishment of currency rating. The currency rating is a function of three parameters where different parameters have different effect on the rating of the currency. The parameters are preferably measured in real time but based on the data gathered through a preset past period of time and through the application of regression analysis and other statistical techniques.

The first parameter of the rating is the velocity of the currency which represents the users' attitude towards a certain currency. The amount of currency in circulation over a certain period of time and the number of users involved in the transactions reflect this parameter. It is measured by extracting data for transactions in which the currency is involved over the measurement period.

The next parameter is the market value of the currency. In order for a market value to be established two things must be implemented in the system—a money market and a unit of account. The money market preferably operates under the rules of a common financial market where users of the systems are entitled to post offers in a virtual public space, open for the rest of the users. A public currency issued by the operator of the system or some sort of central authority may serve as a unit of account. The public currency which will hereinafter be referred to as public currency should be created in the same pattern as the other currencies but it will not have a back-up level value and the market value will always be 1.0 since it represents the exchange rate of a certain currency to the public currency. The market value of a currency is measured in real time through a price discovery process.

The last parameter, namely the back-up level parameter, is established through the measurement of the commercial turnover of the issuer in the payment system. The amount of goods or services sold by the issuer during the measurement period in relation to the total amount of issued currency represents the back-up level of the currency. The back-up level indicates what part of the currency units in circulation can presumably be redeemed for goods and services of the issuer through a certain period of time. The back-up level depends strongly on the money issuance. If a user issues more currency units the back-up level will drop, just as if some of the existing money are extinguished through redemption, the back-up level will rise.

### Payment System

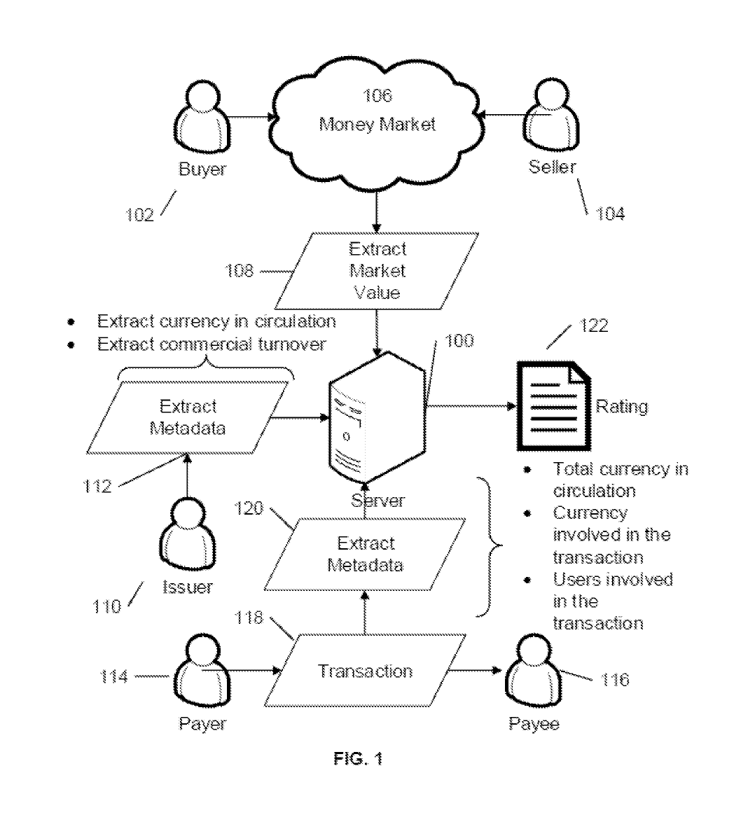

The payment system wherein the method can be implemented will be described with reference to FIG. 1. Users of the system are connected together and with a server (100) through a network, preferably the Internet. Instead of a single server a multitude of servers grouped together can also be used to operate the system. The server (100) is coupled to a database which is not depicted on FIG. 1. The database is used for storing data about users of the system, currency in circulation and transactions. Metadata is extracted by the server (100) from transactions and recorded in the database. The server (100) also executes transactions and issues currency on request of a user through the management of user accounts recorded in the database. Users communicate with the server through data processing devices capable of sending and receiving data over the network and visualizing an interface for user interaction with the system through software installed on the device. These devices may be personal computers, laptops, smart phones, tablets or any other similar device.

Three different processes which are essential for the rating mechanism are illustrated in FIG. 1. The process of money issuance starts with a request from a user in his capacity of currency issuer (110). This process will be explained in details further below in the current description. The back-up level parameter is calculated from the data extracted mainly by the activity of the issuer (112). The data consists of the total amount of the currency units of the rated currency in circulation and the total amount of all currency units transacted to the issuer of the rated currency in commercial transactions. This data is sent to the server (100) which calculates back-up level of the currency.

Another aspect of the rating establishment process is the velocity of money. This parameter is determined through extracting and analyzing data from transactions in the system. In order for a transaction to be executed at least two users must participate—a payer (114) and a payee (116). When a transaction (118) between two users is executed through the server (100) it extracts metadata (120). The metadata consists of the amount of currency involved in the transaction, how it relates to the total amount of currency in circulation and the users involved in the transaction.

The final process of the data retrieving mechanism is associated with the money market implemented in the system. Users participate in the money market (106) as buyers (102) and sellers (104) and always in these two capacities simultaneously since when a user offers to buy a certain amount of a certain currency he respectively offers to sell some of his own currency at a specific exchange rate. A price discovery method is applied to all the offers published in the money market (106) by the server in order to extract market value of each currency on the market (108) where the value represents an exchange rate of the respective currency to the public currency.

Some of the data can be extracted immediately in real time—the market value of the currency since it relies on the real time existing offers in the money market. The velocity of money however should be measured over a certain period of time the length of which should be set by the operator of the system where a longer measurement period will provide more stable data and a shorter period will provide more current and actual data which will most likely tend to be unstable since minor events in the payment system will have a stronger impact on a velocity parameter measured in the short term than in the long term. The back-up level is a mixed parameter. While the amount of the commercial turnover of the issuer is time sensitive data, the relevant amount of currency in circulation is always the one at the point of measurement.

The server will not always be capable of extracting all the data but the server should be customized to set default values for data which cannot be gathered in the system. After all the parameters of the currency are established the server calculates the currency rating (112) and ranks currencies in a descending or ascending order according to their rating.

### Process Flow of the Method

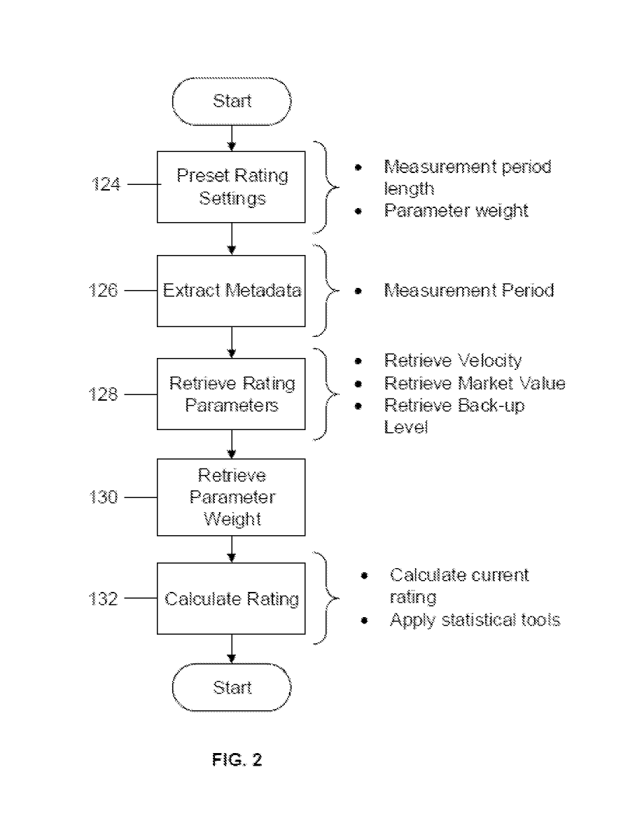

The method of rating establishment will be further explained with reference to FIG. 2. FIG. 2 represents a flow chart of the rating establishment process. At first some rating settings must be set by the operator of the payment system (124). These settings involve on one hand the length of the measurement period. Presumably longer measurement periods will provide more solid data although short term periods can also be used where high amplitudes in the data can be overcome through statistical tools, mainly regression analysis. On the other hand the operator of the payment system must also assign a weighting factor to the three rating parameters. The weighting factor determines what effect the respective parameter will have on the rating compared to the rest of the parameters. In order for the rating to be calculated data must be extracted through the measurement period (126). This data is related to all of the rating parameters and consists of: total amount of currency units in circulation, total amount of currency units involved in transactions, total amount of users involved in transactions with the currency, commercial turnover of the issuer and market value. At the end of the measurement period the rating parameters are calculated and retrieved (128) by the server. The weighting factors for all the parameters are also retrieved by the server (130). Finally the rating is calculated (132). The calculation involves two steps. The first step is the calculation of the rating at the point of measurement. This is the rating in real time. However, in order to overcome large data variability and highly fluctuating ratings statistical tools should also be applied to reduce the effect of random events/outliers and consider a longer term performance of the currency in the payment system.

When any of the data cannot be extracted or is not provided initially the corresponding parameter may be assigned a default value of 0 or any other value determined by the operator of the system.

The processes of retrieving the data for the respective parameter will be explained in the following paragraphs.

### Money issuance and Extinguishment

The money supply is essential to the rating of private currencies in the system. Currencies are called private because each user is entitled to create his own currency and issue currency units.

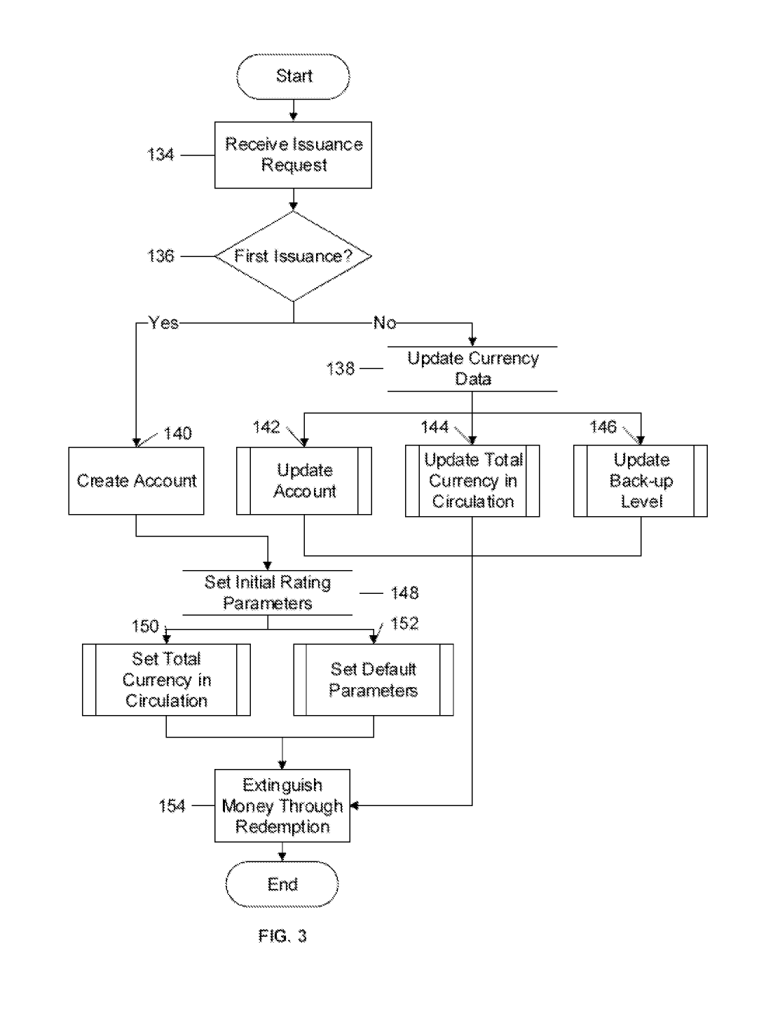

The money supply (issuance and extinguishment) will be explained with reference to FIG. 3. The money issuance starts with a request (134) sent by a user through his data processing device to the server. The server then checks if this is the first issuance requested by that user (136). If so the server creates an account (140). The account is a separated piece of memory in the database used for storing data about the currency. After the creation the server sets some initial rating parameters and rating related data (148). The total amount of currency is recorded (150) and it equals the requested amount of currency units to be issued. Initial values are set for all three of the rating parameters (152). The market value and the velocity of the currency are set to 0 since no transactions involving the currency have been executed in the system. The back-up level however can be measured directly if the issuer has sold goods and services in the system before the money issuance.

### Rating Parameters

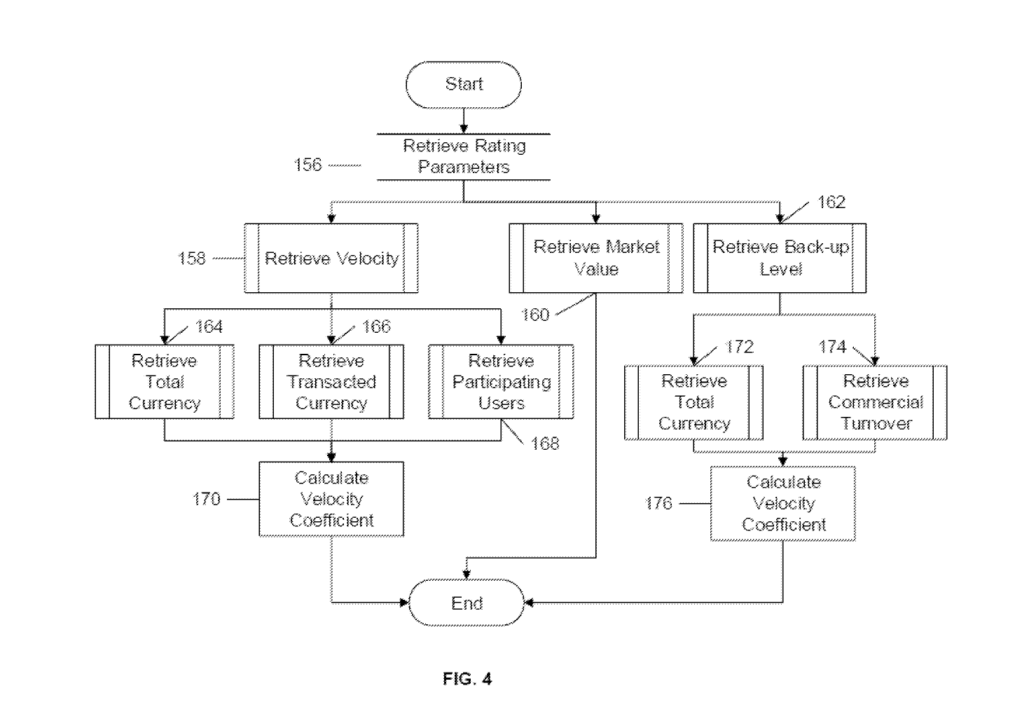

The rating parameters will be briefly described with reference to FIG. 4. As explained above the rating of a certain private currency is calculated through the measurement of three main parameters over a preset period of time. At the end of a measurement period all the data related to the parameters and recorded by the server in the database is retrieved and the parameters are calculated and retrieved (156). When retrieving data for the velocity parameter (158) the server extracts data from the database for the total currency in circulation in the system through the measurement period (164), the total amount of currency units of the rated currency involved in transactions (166) and the total number of users involved in these transactions (168). After all of this data is retrieved from the database, the velocity parameter can be calculated (170).

The market value parameter (160) data is retrieved from the money market implemented in the system and will be further explained below in the current description. No additional data is necessary for the calculation of this parameter.

Retrieving data for the back-up level parameter (162) is similar to the process for the velocity parameter. In order for the back-up level to be calculated the server must extract data for all the currency units of the rated currency in circulation (172) and the commercial turnover of the issuer (174). The relation between these values is the calculated back-up level parameter (176).

### Velocity Parameter

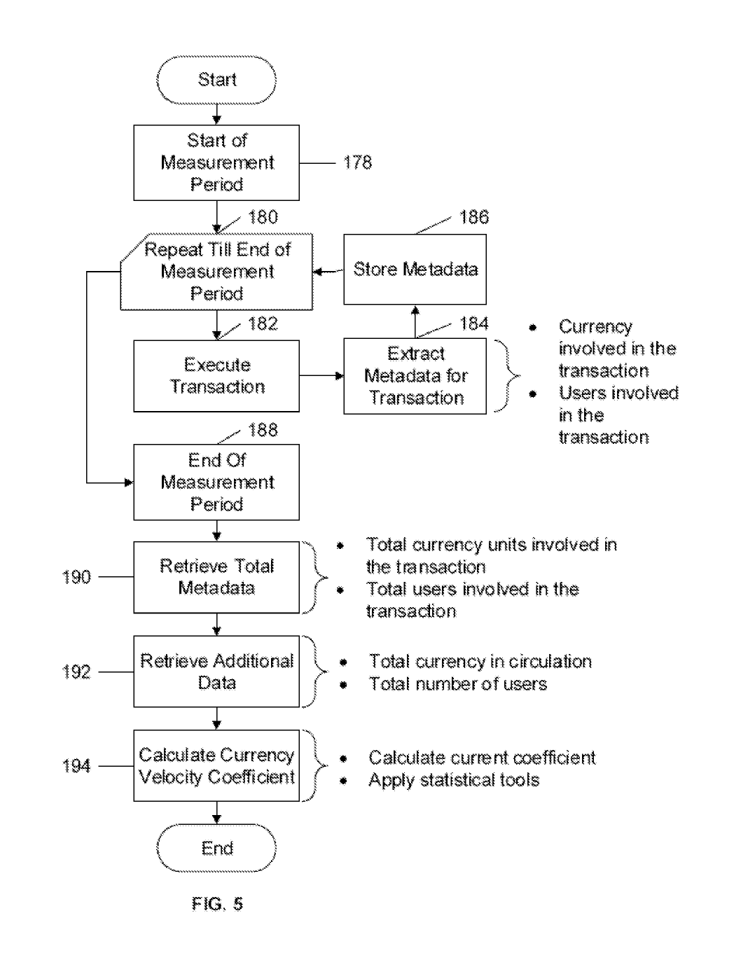

The establishment of the velocity parameter will be explained with reference to FIG. 5. The velocity parameter is measured through a preset period of time the length of which can be determined by the operator of the payment system. During this period of time the server extracts data for all the transactions involving a certain currency and records it in the database. At the end of the period the data is retrieved and the velocity parameter is calculated. Each start of measurement period (178) indicates the end of the previous period. During the measurement period a number of steps is repeated constantly (180). The server anticipates transaction requests form users and when a transaction request is executed (182) it extracts the necessary metadata from it (184). The metadata comprises of the amount of currency transacted and the users participating in the transaction. The data is recorded in the database (186). When another transaction happens the respective metadata is extracted and also recorded within the database where the amount of the transaction is added to the total amount of currency transacted with the previous transactions and if a user is involved in a transaction with the currency for the first time during the measurement period he is also added to the list of users who have used the currency. Metadata is extracted for the velocity coefficient until the end of the measurement period (188). All data extracted after that refers to the next measurement period. In order for the velocity coefficient to be calculated the server extracts from the database data for the total amount of the respective currency transacted during the measurement period and the total number of users involved in transactions with the currency (190). The server than extracts from the database data for the total amount of the currency in circulation in the system and data for the amount of users who have been active during the measurement period (192). Not all of the users may have been involved in transactions in the payment system during the measurement period but the relevant data for the velocity coefficient is the number of users who have participated in transactions. At the end the velocity coefficient is calculated (194).

### Market Value—Price Discovery

The process of currency market value establishment will be explained with reference to FIG. 5. In order for the process to be executed a money market must be implemented in the system. Users of the system are entitled to publish through their data processing devices offers for buying and selling currencies directly on the transfer market which is operated by the server. The server also executes all transactions on the financial market. Each offer of a user must contain the type and amount of currency he wants to buy, the type of currency he wants to sell and the exchange rate. Users are also entitled to buy and sell the public currency in the system which is used for the establishment of the market value. When two offers are matched the server automatically executes a transaction and the order which has been completed is removed from the market.

For example if just a single offer is posted on the money market and it includes a bid for a currency A to be bought with the public currency at an exchange rate of 0.5. Since this is the only bid for currency A on the market the market value of currency A is 0.5. If however another user publishes a bid for currency A for public currency at an exchange rate of 0.6 the server must check both bids and pick the higher exchange rate, in this case 0.6. It is possible that the exchange rate for public currency cannot be extracted directly. For example there may be a single bid to buy currency A for currency B at an exchange rate of 0.5. If this is the only bid on the market for currency A the server will use a virtual chain of transactions to calculate the exchange rate to the public currency by using the exchange rates of the other currencies. In this scenario the server will use the exchange rate of currency B. Let's assume that this rate is 1.0. The exchange rate in the bid for currency A is 0.5. The server will than calculate the exchange rate of currency A to the public currency as 0.5 times the exchange rate of currency B to the public currency, namely 1. This means that although no offers to buy currency A for public currency have been published it has a market value of 0.5.

The steps in the process are as follows: The server firs searches for bids for the currency the market value of which is being calculated (196). Two outcomes are possible depending on whether bids have been found (198). If bids are found the server calculates all exchange rates to the public currency (200) and selects the highest one (202). The market value of the currency is updated according to the new highest exchange rate (204).

If no bids for the currency exist on the market the server assigns a new market value to the currency of 0 (206).

In another aspect of the invention the operator of the system may set a different price discovery process for the currencies on the money market with various conditions that have to be met or taken into account for the evaluation of the market value. These conditions and parameters may include the number of offers, the number of bids and the users who have published bids and offers for the currency on the market.

### Back-Up Level Establishment

The back-up level represents the relation between the total currency units issued by a user and his commercial turnover in the system through the measurement period. At the start of the measurement period (206) the server starts to record data for transactions in which the issuer acts as payee. The following steps are repeated for each transaction during the measurement period (208).

The server waits for transaction of currency units to the issuer (210). When a transaction is executed (212) the server checks if it is a commercial transaction (208).

During this check the server inspects the relation between the payer and the payee and performs a series of tests to establish whether the transaction is part of the commercial turnover of the payee (214). If the transaction is indeed a commercial one its value is recorded in the database (216) and the server starts waiting for another transaction. The amount of each commercial transaction is added to the sum of the previous transaction amounts.

At the end of the measurement period (218) the total amount of the commercial transactions represents the value of the commercial turnover. This data is retrieved by the server (222) together with the data for the total currency units of the rated currency in circulation (220). Finally the back-up level at the exact measurement point is calculated as the relation between these two parameters.

What is claimed is:

1. A method comprising:
1.1 providing, through data processing devices, a server or a multitude of servers and a database, coupled together through a network, a payment system where each user is entitled to create his own currency in a certain pattern;
1.2 the currency being generated through the server upon request of the users where each currency has at least the following parameters:
(1) a velocity coefficient associated with what the attitude of the users towards a certain currency;
(2) market value representing the exchange rate of the currency for a centrally issued public currency;
(3) back-up level associated amount of goods and services a user acting as an issuer of currency can presumably provide in the system compared to the total amount of currency units created upon his initiative;
1.3 establishing a rating for each currency as a function of the currency parameters; ranking the currencies in a descending order starting with the one with the highest rating;

2. The method of claim 1 where only one or part of the parameters are used for establishment of currency rating;

3. The method of claim 1 where the velocity coefficient depends on what amount of the currency has been involved in transactions over a certain period of time compared to the total amount of the currency created and the amount of users involved in transactions with the currency compared to the total amount of users involved in any transactions in the system during the same period of time;

4. The method of claim 1 where the market value is determined through a price discovery process from a money market with plurality of offers published by the users of the system;

5. The method of claim 4 where the offers comprise: currency to be bought and amount of currency to be bought, currency to be sold, exchange rate;

6. The method of claim 1 where the back-up level is a function of the amount of currency which can be redeemed for goods and services offered by the issuer.
